(19) United States
(12) Patent Application Publication
(10) Pub. No.: US 2021/0205892 A1
(43) Pub. Date: Jul. 8, 2021

(54) PRINTING DEVICES

(71) Applicant: Hewlett-Packard Development Company, L.P., Spring, TX (US)

(72) Inventor: Seongsik Chang, Palo Alto, CA (US)

(73) Assignee: Hewlett-Packard Development Company, L.P., Spring, TX (US)

(21) Appl. No.: 17/043,101

(22) PCT Filed: Jun. 8, 2018
(86) PCT No.: PCT/US2018/036713

§ 371 Date: Sep. 29, 2020

(51) Int. Cl. B22F 12/41; B33Y 10/00; B33Y 30/00; B22F 10/28

(52) U.S. Cl. CPC B22F 12/41; B22F 10/28; B33Y 30/00; B33Y 10/00

(57) ABSTRACT

A printing device that includes a build platform to hold an amount of build material thereon and a coherent light source to selectively fuse the build material through heat produced by the coherent light source at the surface of the build material wherein the coherent light source flood radiates the entirety of the build platform.

### BACKGROUND

Additive manufacturing systems produce three-dimensional (3D) objects by building up layers of material and combining those layers using adhesives, heat, chemical reactions, and other coupling processes. Additive manufacturing may involve the application of successive layers of material to make solid parts. One example of an additive manufacturing process is three-dimensional (3D) printing. 3D printing may be used in rapid product prototyping, mold generation, mold master generation, and short run manufacturing. Some 3D printing methods use chemical binders or adhesives to bind build materials together. Other 3D printing methods may involve partial curing, thermal merging/fusing, melting, and sintering, among other processes of the build material, and the mechanism for material coalescence may depend upon the type of build material used. For some materials, partial melting may be accomplished using heat-assisted extrusion, and for some other materials (e.g., polymerizable materials), curing or fusing may be accomplished using, for example, ultra-violet light or infrared light. Additive manufacturing systems make it possible to convert a computer aided design (CAD) model or other digital representation of an object into a physical object. Digital data is processed into slices each defining that part of a layer or layers of build material to be formed into the object.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a printing device according to an example of the principles described herein.

FIG. 2 is a flowchart showing a method for additive manufacturing of metals according to an example of the principles described herein.

FIG. 3 is a block diagram of a three-dimensional (3D) additive manufacturing printing device according to an example of the principles described herein.

FIG. 4 is a schematic, side cross-sectional view of an additive manufacturing device implementing a fiber laser according to an example of the principles described herein.

FIG. 5 is a schematic, side cross-sectional view of an additive manufacturing device implementing an array of VCSELs according to an example of the principles described herein.

FIG. 6 is a schematic, side cross-sectional view of an additive manufacturing device implementing a plurality of fiber lasers according to an example of the principles described herein.

FIG. 7 is a schematic, side cross-sectional view of an additive manufacturing device implementing an array of VCSELs according to an example of the principles described herein.

FIG. 8 is a schematic, side cross-sectional view of an additive manufacturing device implementing a plurality of fiber lasers according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In examples of the methods for additive manufacturing of metals disclosed herein, photonic fusion is used. Photonic fusion may be faster, more efficient, and less expensive than other additive manufacturing processes (e.g., selective laser sintering (SLS), selective laser melting (SLM), scanning electron beam melting, etc.). In examples of photonic fusion as disclosed herein, a build material layer is exposed to radiated energy from a flood energy source. The flood energy source exposes the entire build material layer to the radiated energy without scanning the layer. The radiated energy causes a consolidating transformation of the build material in the exposed layer. In the present specification and in the appended claims, the term “photonic fusion” is meant to be understood as the use of a photon source such as a fiber laser, a vertical-cavity surface-emitting laser (VCSEL), or any other electromagnetic radiation source. In these examples, the photons produced by these electromagnetic sources may heat the build material to the point of coalescing or fusing together of the material.

Build materials, according to any example presented herein, may include a metal. The metal may be in powder form, i.e., particles. In the present disclosure, the term “particles” means discrete solid pieces of components of the build material. As used herein, the term “particles” does not convey a limitation on the shape of the particles. As examples, the metal particles may be non-spherical, spherical, random shapes, or combinations thereof. The metal particles may also be similarly sized particles or differently sized particles. The individual particle size of each of the metal particles is up to 100 micrometers (μm). In an example, the metal particles may have a particle size ranging from about 1 μm to about 100 μm. In another example, the individual particle size of the metal particles ranges from about 1 μm to about 30 μm. In still another example, the individual particle size of the metal particles ranges from about 2 μm to about 50 μm. In yet another example, the individual particle size of the metal particles ranges from about 5 μm to about 15 μm. As used herein, the term “individual particle size” refers to the particle size of each individual build material particle. As such, when the metal particles have an individual particle size ranging from about 1 μm to about 100 μm, the particle size of each individual metal particle is within the disclosed range, although individual metal particles may have particle sizes that are different than the particle size of other individual metal particles. In other words, the particle size distribution may be within the given range. The particle size of the metal particles refers to the diameter or volume weighted mean/average diameter of the metal particle, which may vary, depending upon the morphology of the particle.

In an example, the metal may be a single phase metallic material composed of one element. In this example, the sintering temperature of the build material may be below the melting point of the single element. In another example, the metal may be composed of two or more elements, which may be in the form of a single phase metallic alloy or a multiple phase metallic alloy. In these other examples, sintering may occur over a range of temperatures.

In some examples the metal is aluminum (Al) or an alloy thereof. In one of these examples, the metal is AlSi10Mg. AlSi10Mg is an aluminum alloy including; from 9 wt % to 11 wt % of Si; from 0.2 wt % to 0.45 wt % of Mg; 0.55 wt % or less of Fe; 0.05 wt % or less of Cu; 0.45 wt % or less of Mn; 0.05 wt % or less of Ni; 0.1 wt % or less of Zn; 0.05 wt % or less of Pb; 0.05 wt % or less of Sn; 0.15 wt % or less of Ti; and a balance of Al. When the metal is AlSi10Mg, the metal may be suited for thermal and/or low weight applications. In other examples, the metal may be 2xxx series aluminum or 4xxx series aluminum.

The present specification describes a printing device that includes a build platform to hold an amount of build material thereon and a coherent light source to selectively fuse the build material through heat produced by the coherent light source at the surface of the build material wherein the coherent light source radiates the entirety of the build platform.

The present specification also describes a method for additive manufacturing of metals that includes spreading a build material including a metal in a sequence of layers, each layer having a respective thickness, a respective sequence position, and a respective exposed surface, an entirety of which to be radiantly exposed, in a single application, to an electromagnetic radiation source prior to spreading of a subsequent layer and exposing, layer-by-layer, the exposed surface of each layer to the electromagnetic radiation source, the energy radiated at an intensity profile and a fluence sufficient to cause a consolidating transformation of the build material in the exposed layer.

The present specification further describes three-dimensional additive manufacturing printing device that includes a build material distributor to spread a build material including a metal in a sequence of layers; a build platform to receive the sequence of layers of build material; and an electromagnetic radiation source to radiate an entirety of each of the layers of build material and selectively fuse the build material wherein energy radiated by the electromagnetic radiation source has an intensity profile and a fluence sufficient to cause a consolidating transformation of the build material in the respective exposed layer.

As used in the present specification and in the appended claims, the term “intensity” is meant to be understood as the power per area (e.g., kilowatts per square centimeter (kW/cm²)) of a radiated electromagnetic radiation. As used in the present specification and in the appended claims the term “fluence” is meant to be understood as the total energy per area (e.g., Joules per square centimeter (J/cm²)) of the radiated electromagnetic radiation.

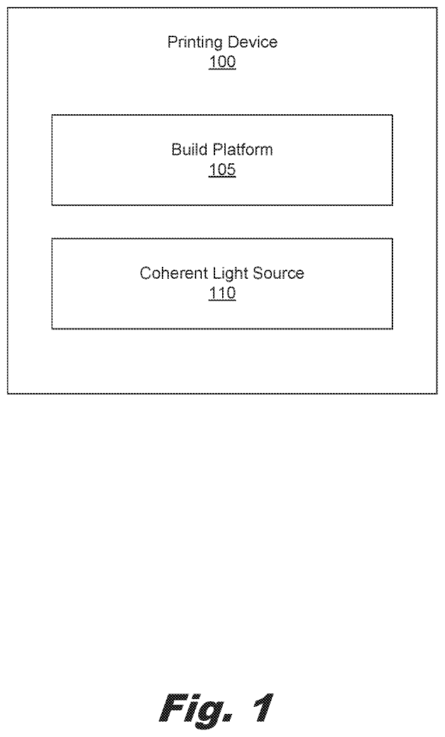

Turning now to the figures, FIG. 1 is a block diagram of a printing device (100) according to an example of the principles described herein. The printing device (100) may be an additive manufacturing printing device as described herein. In an example, the printing device (100) may include a build platform (105). The build platform (105) may be any surface onto which the printing device (100) may deposit an amount of build material thereon. In any example presented herein, the printing device (100) may include any deposition device to deposit the build material on the build platform (105). This deposition device may include a hopper to drop sequential layers of build material onto the surface of the build platform (105) and/or onto a surface of a previously deposited layer of build material. The roller may be used to evenly spread the build material on the surface of the build platform (105) and/or over the surface of a previously deposited layer of build material.

In any example presented herein, the printing device (100) may include a coherent light source (110). When activated, the coherent light source (110) may selectively fuse the build material through heat produced by the coherent light source (110) at the surface of the build material. In an example, the coherent light source (110) is a flood energy source. A flood energy source exposes the entirety of a layer of deposited build material without scanning across the build material. During operation, flooding the build material by exposing the entirety of the layer of build material may increase the speed of fusing of the build material for that layer thereby increasing the speed of formation of a 3D object from the successively deposited layers of build material. This may reduce both the 3D manufacturing process time as well as reduce costs in operation of the printing device (100).

In any example presented herein, the coherent light source (110) may be a fiber laser, A fiber laser is a laser in which the active gain medium is an optical fiber doped with rare-earth elements such as erbium, ytterbium, neodymium, dysprosium, praseodymium, thulium and holmium. In any example presented herein, the fiber laser may have an energy output that can deliver 30 joules per cm² and 10 kilo watts per cm² for a given build area.

By way of example, an area of a build platform may be 10 cm by 10 cm. Consequently, the printing device (100) may implement a light source such as the fiber laser described herein that may deliver an energy of (30 J/cm²)*(100 cm²)=3 kJ of energy. The fiber laser may further have a peak power of (10 kW/cm²)*(100 cm²)=1 MW. Although this is an example, the present specification contemplates a build platform smaller or larger than 100 cm². With the smaller or larger build platforms, the energy output and peak power of the fiber laser may be reduced or increased, respectively, in order to provide proportionate energy to the build material sufficient to fuse the build material.

Other examples also exist where different build materials fuse at different temperatures such that the energy output and peak power of the fiber laser may be decreased or increased sufficient to cause the fusion of the build material as described herein,

An example of a fiber laser that may be used in connection the present description is the Highlight FL1000P produced by Coherent® that produces 1 kW of power, 100 mJ pulses at 10 kHz, and 1.7 MW of peak power, In this example, fora 10 cm by 10 cm area, a total of three FL1000P devices may be used to have 1 kJ of energy over 1 sec. This may produce sufficient peak power during a fusing process of the build material. In an example, a single FL1000P may be used over an area that is 5 cm by 5 cm, With these levels of power and energy outputs, the fiber laser may sinter, fuse, and/or coalesce the build material together to form the 3D object on the build platform based on the power and/or energy outputs.

In order to serve as a flood energy source, the printing device (100) may include a number of lenses, shaping tools, and/or mirrors to selectively control the direction and focusing of the light emitted from the fiber laser. In an example, the fiber laser may have an aperture that is about 400 μm in diameter. Consequently, the beam produced by the fiber laser expands according to that numerical aperture. In an example, a collimating lens may be used to deliver collimated light to the layer of build material. In an example, the beam of light produced by the fiber laser may be shaped using a beam shaping tool that may transform a circular pattern of light into a shape that matches the shape of the build platform (105); i.e., a square. This collimation of light and shaping of the light may be relatively easier to accomplish with the fiber laser than with, for example, a flash lamp such as a xenon pulse lamp.

During operation of the fiber laser, a masking process may be implemented in order to selectively prevent certain areas of the build material layer from being coalesced. In an example, a physical masking sheet may be placed over the build material layer to prevent the heat from the fiber laser from reaching these certain portions. In another example, a reflective agent may be selectively jetted across the surface of the build material by, for example, a printhead device in order to reflect the light produced by the fiber laser. In this example, the reflective agent may be selectively dispersed at locations where the beam is not to be absorbed thereby preventing the fusing of the build material at those locations. In an example, a light absorbing agent may be selectively jetted across the surface of the build material using the printhead device at locations where the beam is to be absorbed by the build material. The light absorbing agent may cause light to be absorbed at those locations such that the build material may be fused together. In still other examples, an array of micromirrors may be used to, pixel-by-pixel, selectively direct the collimated beam of the fiber laser towards or away from the build material layer. The micromirrors, in this example may be similar to those used in a digital light processing device. Other examples may be implemented and the present description contemplates the use of any of the examples presented herein as well as other types of device and/or process either in combination or alone that may selectively direct or misdirect the beam from the fiber laser towards or away from the layer of build material on the build platform (105).

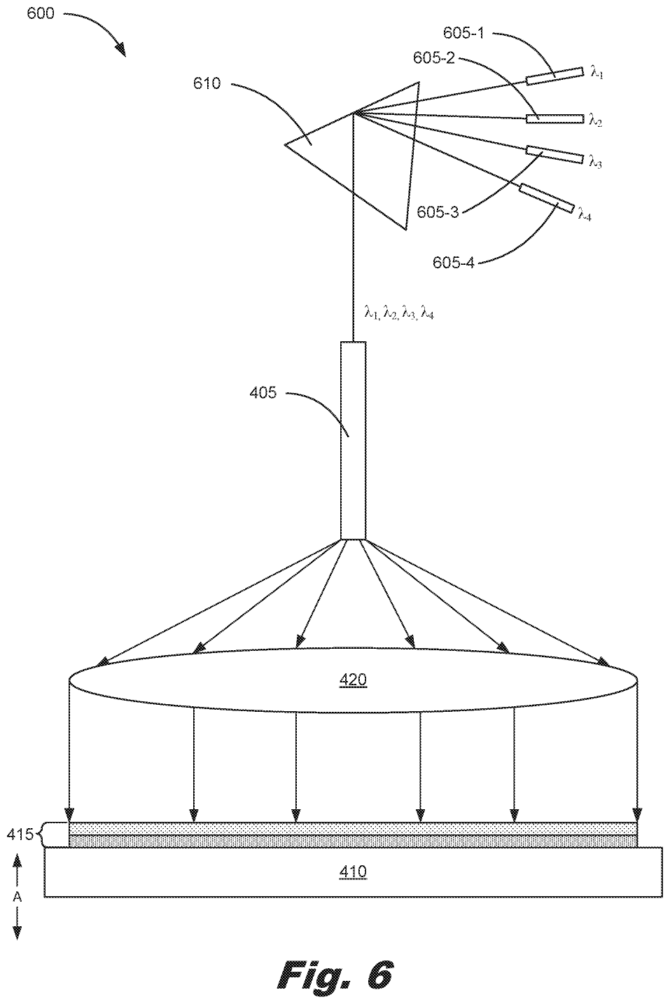

In an example, the fiber laser may include a plurality of fiber lasers; each fiber laser producing a different wavelength of light. In this example, there may be situations where additional output is used to selectively fuse amounts of build material together. In this example the printing device (100) may optically associate a prism with the plurality of fiber lasers. In this example, shown and described in more detail in FIG. 6, the varying wavelengths of light originating from each of the plurality of fiber lasers may be merged via the prism and into a single fiber laser as described above.

In another example, a plurality of fiber lasers may be used with each fiber laser having the same wavelength. In this example, each of the plurality of fiber lasers may be paired with a collimating lens as described above. The collimated light from each of the fiber laser/collimating lens pair may, in combination, flood the entirety of the build platform and/or layer of build material. In another example, the collimated light from each of the fiber laser/collimating lens pair may, each, direct their respective beams to a portion of the build platform (105) and/or layer of build material that, in sum, fills the whole of the build platform (105) and/or build material.

In any example presented herein, the coherent light source (110) may be a vertical-cavity surface-emitting laser (VCSEL). In an example, the vertical-cavity surface-emitting laser (VCSEL) may include a plurality of VCSELs arranged in an array of VCSELs. With a VCSEL, each portion or “pixel” of the layer of build material laid on the build platform (105) and/or a previously deposited layer of build material may be subjected to the photonic fusion from an individual VCSEL. With the array of VCSEL, a one-to-one mapping to the layer of build material may be conducted allowing selective application of the beams from each of the VCSELs. In an example, the VCSEL may have 1-30 mW of power from a 4-20 μm diameter VCSEL. This may correspond to 7.5 kW/cm², and 30 J/cm² can be achieved within a 4 msec time duration. In an example, the VCSELs may be operated in a pulse mode where the VCSELs may be repeatedly turned off and on for any given layer any number of times in order to complete the fusing process of the build material.

Light emission from each of the VCSELs expands according to numerical aperture of the VCSELs themselves, and therefore, the array of VCSELs may be placed in close proximity to the build material on the build platform (105). In this example, the array of VCSELs may be moved up and down, that is, away from and close to, respectively, the build material during a fusing process,

In an example, each of the VCSELs in the array of VCSELs may be paired up with a microlens. Each microlens may be used to collimate the beams from each of the VCSELs thereby allowing the array of VCSELs to be placed a distance away from the build material. In this example, a build material deposition device may be allowed to pass in between the build platform (105) and the array of VCSELs between intermittent uses of the array of VCSELs to fuse a previously deposited layer of build material.

In any example presented herein, the printing device (100) may be used to form a 3D object. The process of forming this 3D object may include the spreading a build material such as a metal in a sequence of layers, each layer having a respective thickness, a respective sequence position, and a respective exposed surface to receive radiated energy from the coherent light source (110) prior to spreading of a subsequent layer. In any example presented herein, each respective exposed surface has a surface area of about 5 square centimeters (cm2), The process may also include exposing, layer-by-layer, the exposed surface of each layer to the radiated energy from the coherent light source (110), the energy radiated at any intensity profile and at a fluence sufficient to cause a consolidating transformation of the build material in the exposed layer.

In any example presented herein, the coherent light source (110) may be used to apply the beam of light to the surface of any layer of the build material any number of times. In some examples, a first application of the electromagnetic radiation by the coherent light source (110) may be used to prepare the build material prior to fusing using a second application of the electromagnetic radiation. Indeed, any number of applications of electromagnetic radiation at any type of intensity profile may be used to appropriate fuse the build material. Factors that may adjust the timing of the application of electromagnetic radiation, the frequency of the application of electromagnetic radiation, and/or the type of coherent light source (110) used may include, for example, the type of build material, the size of the granules of build material, the distance of the build material from the coherent light source (110), the amount of build material in any given layer to be fused, the amount of build material to be and that has been fused in neighboring layers of build material to the current build layer addressed, and the temperature around the build material, among other factors,

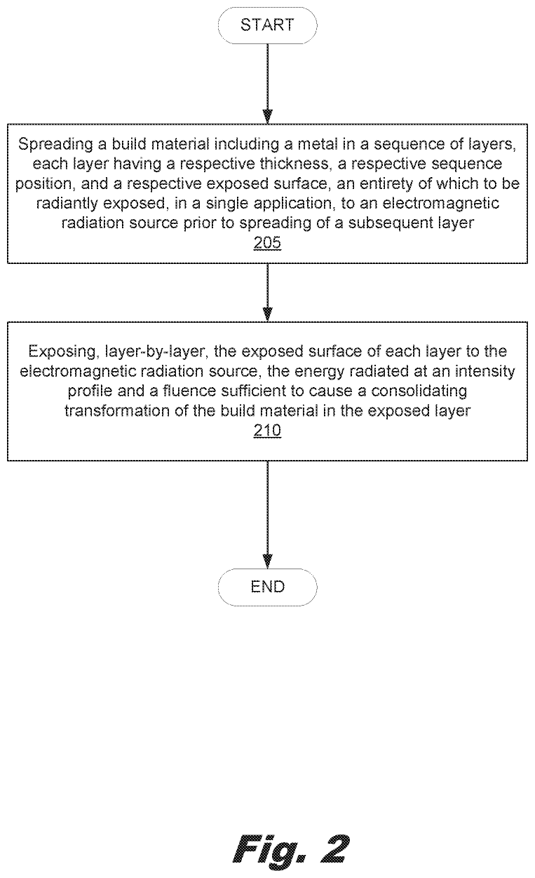

FIG. 2 is a flowchart showing a method (200) for additive manufacturing of metals according to an example of the principles described herein. The method (200) may include spreading (205) a build material including a metal in a sequence of layers, each layer having a respective thickness, a respective sequence position, and a respective exposed surface, an entirety of which to be radiantly exposed, in a single application, to an electromagnetic radiation source prior to spreading of a subsequent layer. The method (200) may further include exposing (210), layer-by-layer, the exposed surface of each layer to the electromagnetic radiation source, the energy radiated at an intensity profile and a fluence sufficient to cause a consolidating transformation of the build material in the exposed layer. As described above, by exposing the entirety of the layer of build material at a single time, the process of fusing some or all of the build material on the build platform (105), may be increased thereby reducing the overall time used to create a 3D object using the printing device (100).

As described herein, the source of the electromagnetic radiation may be a coherent light source (110) such as a fiber laser and/or a VCSEL. Each of these devices may have sufficient power and energy to fuse the build material. Additionally, as described herein, the fiber lasers and VCSELs may be used in conjunction with any number of lenses, beam formers, and/or micromirros to direct, collimate, and/or shape the beam originating from these electromagnetic radiation sources.

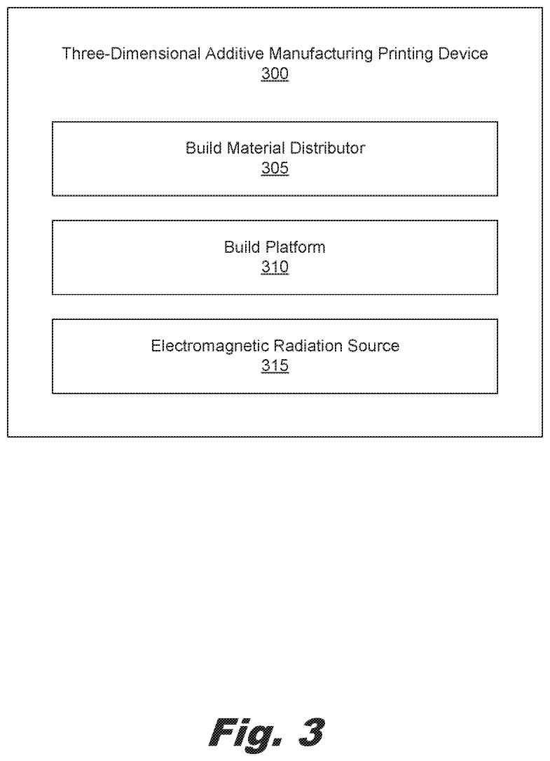

FIG. 3 is a block diagram of a three-dimensional (3D) additive manufacturing printing device (300) according to an example of the principles described herein. The 3D additive manufacturing printing device (300) may include a build material distributor (305), a build platform (310), and an electromagnetic radiation source (315).

The build material distributor (305) may include any device or devices that may place a layer, however thick, on the build platform (310) and/or a previously deposited layer of build material. In an example, the build material distributor (305) may include a hopper. The hopper may include any vessel used to hold an amount of build material therein. A controller of the 3D additive manufacturing printing device (300) may direct any number of motors to move the hopper across the build platform (310) while concurrently opening a hatch in the hopper to deposit an amount of build material on the build platform (310). The build material distributor (305) may also include a number of rollers or other types of spreading devices. The controller may also control, for example, a motor to direct the roller and/or spreading device over the surface of the build platform (310) and/or previous layer of build material. The roller and/or other spreading device may evenly distribute the build material to form an even layer of build material.

The build platform (310) may be any surface onto which the 3D object and the layers of build material may be formed and placed, respectively. In an example, as additional layers of build material are deposited by the build material distributor (305), the build platform (310) may be moved downward and away from the electromagnetic radiation source (315) so as to allow the electromagnetic radiation source (315) to radiate a newly added layer of build material at the same or similar distance. This allows for the same or similar intensity profile of the electromagnetic radiation source (315) to be applied to the surface of the build material.

The electromagnetic radiation source (315) may, in an example, be any coherent light source (110) similar to those described herein. Again, the electromagnetic radiation source (315) may have any level of power and/or intensity to fuse the build material as described herein. The amount of power and/or energy used by the 3D additive manufacturing printing device (300) may depend on the type and operation of the coherent light source (110) used.

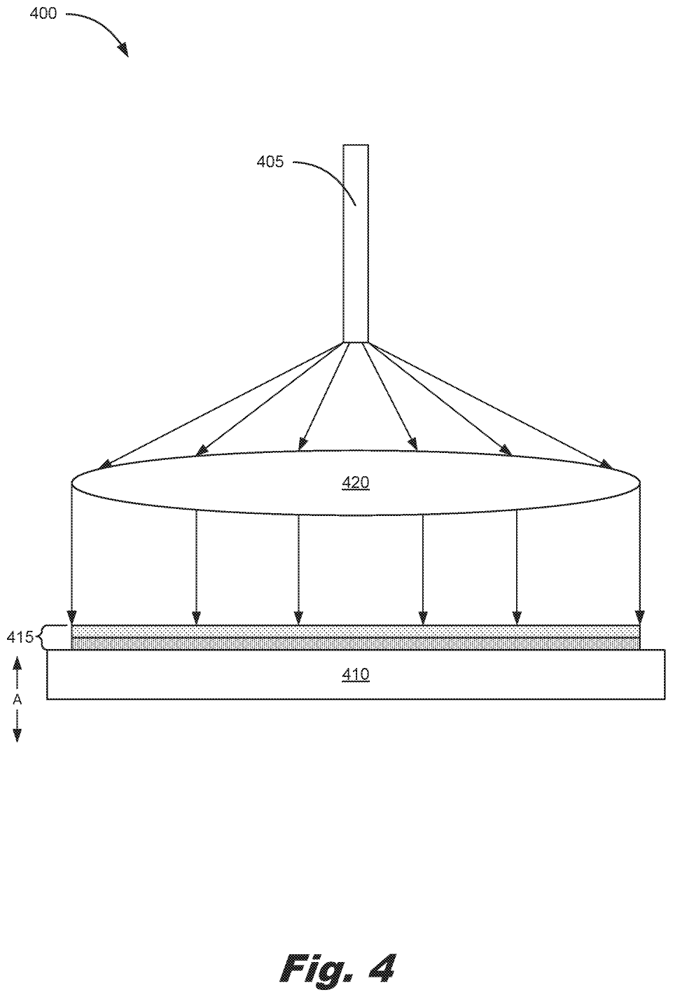

FIG. 4 is a schematic, side cross-sectional view of an additive manufacturing device (400) implementing a fiber laser (405) according to an example of the principles described herein. In this example, the additive manufacturing device (400) includes a build platform (410) to maintain any number of layers of build material (415) thereon. As descried herein, the build platform (410) may move up or down according to arrow (A) as depicted in FIG. 4. This is to accommodate successive layers of build material (415).

The additive manufacturing device (400) may include a collimating lens (420). The collimating lens (420) may collimate the beam of electromagnetic radiation originating from the fiber laser (405) so as to flood the entirety of a layer of build material deposited onto the build platform (410). Again, by flooding the entirety of the build material on the build platform (410), the additive manufacturing device (400) may cause those portions to be fused by the electromagnetic radiation to be fused at a single time instead of scanning the fiber laser (405) across the surface of the build material. This results in a quicker fusing process between successive depositions of layers of build material. Consequently, any given 3D object may be formed relatively quicker than would otherwise have been done using a scanning process.

In any example presented herein, a DLP-type array of micromirros may be placed below the collimating lens (420) to selectively direct the electromagnetic radiation originating from the fiber laser (405). Each of the micromirrors may either direct the electromagnetic radiation from the fiber laser (405) towards a location on the build platform (410) or direct the electromagnetic radiation away from the build material (415). In this example, the selective fusing of selected portions of the build material may be realized using the array of micromirros.

In other examples, a deposition device may be used to distribute build material and/or other types of materials used to form the 3D object. As described, the deposition device may deposit an amount of build material over the build platform (410) and/or a previously deposited layer of build material. The deposition device may also be used to deposit, for example, a reflective agent, a light absorbing agent, a coloring agent, and/or a build material suspension agent, among other types of agents. These agents may help or hinder the fusing of the build material, the coloring of the build material, and/or the delivery of certain types of build material to the build platform (410).

FIG. 4 shows a number of layers of build material (415) formed on the build platform (410). In this example, each lower layer of build material (415) may include fused and un-fused portions of build material. In this example, an uppermost layer of build material (415) may be made entirely of un-fused build material (415) or fused and un-fused build material based on whether the electromagnetic radiation from the fiber laser (405) has been applied to the build material (415) as described herein.

In any example presented herein, the application of the electromagnetic radiation from either the fiber laser (405) or the VCSELs described herein as well as the application of any reflective agent, light absorbing agent, coloring agent, and/or build material suspension agent may be according to a digital version of a 3D object to be formed. The additive manufacturing device (400) may, via a controller, deposit the build material and apply any of the build material (415) and reflective agent, light absorbing agent, coloring agent, and/or build material suspension agent on a layer-by-layer basis according to a rendered digital layer of the digital 3D object. Specifically, the controller may process “control build material supply” data, and in response cause the build material to be appropriately positioned on the build platform (410) and may process “control spreader” data, and in response, control the deposition device to deposit and spread the supplied build material (415) over the build platform (410) to form the sequence of layers thereon as described herein.

The controller may process manufacturing data that may be based on a 3D object model of the 3D object/part to be generated. In response to data processing, the controller may control the operations of the build platform (410), the deposition device, and the fiber laser (405). As an example, the controller may control actuators (not shown) to control various operations of the components of the additive manufacturing device (400). The controller may be a computing device, a semiconductor-based microprocessor, a central processing unit (CPU), an application specific integrated circuit (ASIC), and/or another hardware device. The controller may be connected to the components of the additive manufacturing device (400) via hardware communication lines, or wirelessly via radio or photonic communication.

The controller may manipulate and transform data, which may be represented as physical (electronic) quantities within the additive manufacturing device's (400) registers and memories, in order to control the physical elements to create the 3D object. As such, the controller may be in communication with a data storage device. The data storage device may also be referred to as a computer memory. The data storage device may include data pertaining to a 3D object to be manufactured by the additive manufacturing device (400). The data for the selective delivery of the build material, etc. may be derived from a model of the 3D object to be formed. The data storage device may also include machine readable instructions (stored on a non-transitory computer readable medium) that are to cause the controller to control the amount of build material (415) that is supplied by the deposition device, the movement of the build platform (410), the movement of the deposition device, etc.

The additive manufacturing device (400) may be utilized in any data processing scenario including, stand-alone hardware, mobile applications, through a computing network, or combinations thereof. Further, the additive manufacturing device (400) may be used in a computing network, a public cloud network, a private cloud network, a hybrid cloud network, other forms of networks, or combinations thereof. In one example, the methods provided by the additive manufacturing device (400) are provided as a service over a network by, for example, a third party. The present systems may be implemented on one or multiple hardware platforms, in which the modules in the system can be executed on one or across multiple platforms. Such modules can run on various forms of cloud technologies and hybrid cloud technologies or offered as a SaaS (Software as a service) that can be implemented on or off the cloud. In another example, the methods provided by the additive manufacturing device (400) are executed by a local administrator.

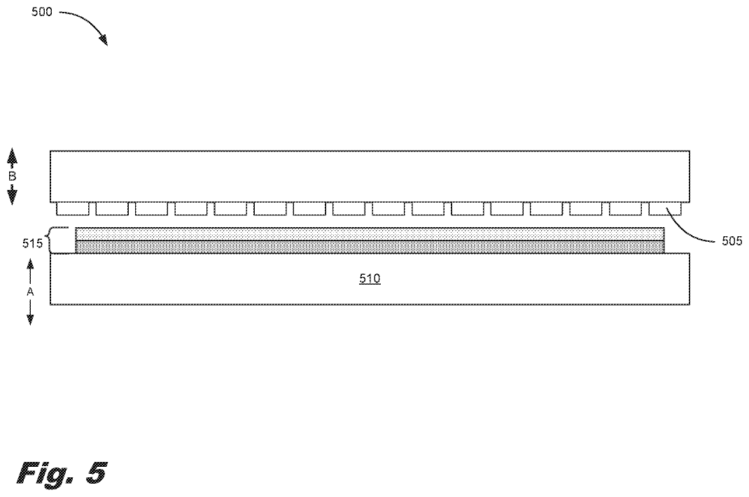

FIG. 5 is a schematic, side cross-sectional view of an additive manufacturing device (500) implementing an array of VCSELs (505) according to an example of the principles described herein. As described herein, the array of array of VCSELs (505) may be moved up and down according to arrow (B) as shown in FIG. 5. Similar to FIG. 4, the array of VCSELs (505) may emit electromagnetic radiation to specific portions of the surface of the build material (515). In an example, each of the VCSELs within the array of VCSELs (505) may be addressed to a specific “pixel” or defined area on the surface of the build material (515) in order to or not to fuse the build material at that pixel. In this example, due to the aperture of each of the VCSELs, the array of VCSELs (505) may be placed relatively closer to the surface of the build material (515) as compared to the fiber laser described in connection with FIG. 4. In the examples shown in FIG. 5, a deposition device may deposit an amount of build material (515) on the surface of the build platform (510) after the array of VCSELs (505) have been moved upwards according to arrow (B). This process may take additional time to allow the array of VCSELs (505) to be moved so that the deposition device may deposit each successive layer of build material (515).

FIG. 6 is a schematic, side cross-sectional view of an additive manufacturing device (600) implementing a plurality of fiber lasers (605-1 through 604-4) according to an example of the principles described herein. Similar elements represented in connection with FIG. 4 are repeated here in FIG. 6 and will not be discussed in detail for brevity but are described herein in connection with FIG. 4 instead.

In this example as described herein, each of the plurality of fiber lasers (605-1 through 604-4) may produce a distinct wavelength of electromagnetic radiation (λ₁, λ₂, λ₃, λ₄). These different wavelengths may be used to provide, at the surface of the build material (415) a broader spectrum of electromagnetic radiation than would be otherwise realized with a single fiber laser. Additionally, with the plurality of fiber lasers (605-1 through 604-4), the power and/or energy of the electromagnetic radiation may be increased.

The electromagnetic radiation emissions from each of the plurality of fiber lasers (605-1 through 604-4) may be accumulated and focused as a single beam into another fiber laser (405) as described in connection with FIG. 4. As described in FIG. 4, the conglomerated beams may then be directed to the surface of the build material (415) with or without an array of micromirrors.

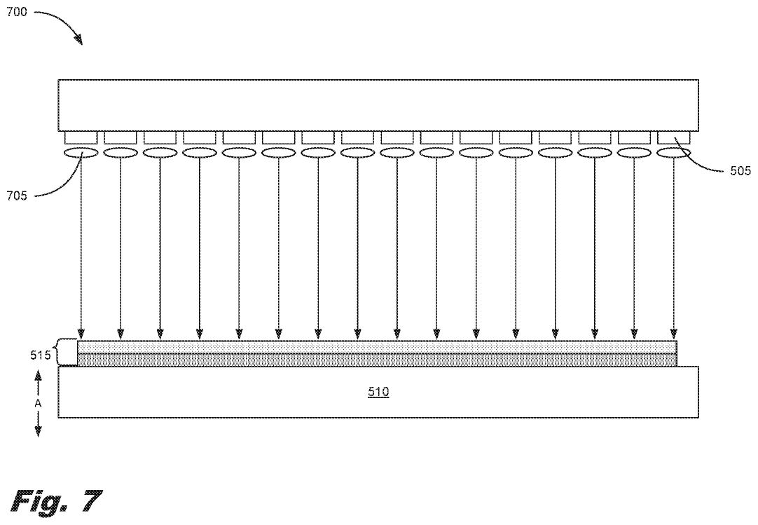

FIG. 7 is a schematic, side cross-sectional view of an additive manufacturing device (700) implementing an array of VCSELs (505) according to an example of the principles described herein, Similar elements represented in connection with FIG. 5 are repeated here in FIG. 7 and will not be discussed in detail for brevity but are described herein in connection with FIG. 5 instead. In this example, instead of the array of VCSELs (505) being moved up and down, each VCSEL (505) may be paired with a collimating lens (705). Each collimating lens (705) may collimate the electromagnetic radiation produced by each VCSEL (505) such that the array of VCSELs (505) may be place at a higher location relative to that described in connection with FIG. 5. In this example, a build material (515) deposition device may be allowed to pass underneath the array of VCSELs (505) cutting down on operating time. The placement of the array of VCSELs (505) at this higher location reduces the complexity of the additive manufacturing device (700) by not using a motor or gears to move the array of VCSELs (505) up and down. Additionally, because the array of VCSELs (505) may be in a fixed location, the accuracy of the collimated light from the VCSELs (505) may be increased. Still further, because the array of VCSELs (505) does not move to allow a build material (515) deposition device to deposit the build material (515), the time used in building a 3D object may be significantly reduced cutting down in operating expenses associated with such a build.

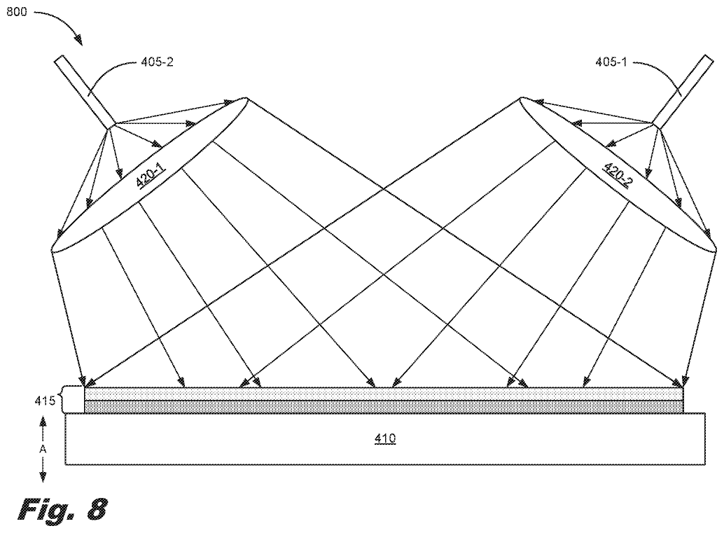

FIG. 8 is a schematic, side cross-sectional view of an additive manufacturing device (800) implementing a plurality of fiber lasers (405-1, 405-2) according to an example of the principles described herein. Similar elements represented in connection with FIG. 4 are repeated here in FIG. 8 and will not be discussed in detail for brevity but are described herein in connection with FIG. 4 instead.

The additive manufacturing device (800) may implement, in this example, two fiber lasers (405-1, 405-2). In this example, each of the fiber lasers (405-1, 405-2) emit the same wavelength of electromagnetic radiation. Additionally, each of the fiber lasers (405-1, 405-2) are paired with its own collimating lens (420-1, 420-2) to, again, collimate the emitted electromagnetic radiation from the fiber lasers (405-1, 405-2). In this example, each of the fiber lasers (405-1, 405-2) may flood the entirety of the build material (415) on the build platform (410). In this example the inclusion of the plurality of fiber lasers (405-1, 405-2) may increase the power, energy, and/or intensity of the electromagnetic radiation on the build material (415). This allows certain other types of materials used as the build material (415), some of which may implement a relatively higher intensity of electromagnetic radiation to fuse.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general-purpose computer, special purpose computer, or other programmable data processing apparatus to produce a machine, such that the computer usable program code, when executed via, for example, the controller of the additive manufacturing printing device or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The specification and figures describe an additive manufacturing printing device that floods an entirety of a layer of build material using a fiber laser, a VCSEL or combinations thereof. The use of the fiber laser may allow for a relatively uniform beam. Additionally, the beam of a fiber laser may be shaped to fit the build platform. The fiber laser may be relatively flexible so that the placement of the fiber laser within the additive manufacturing device may be varied based on other devices to be placed in the device.

The preceding description has been presented to illustrate and describe examples of the principles described. This description is not intended to be exhaustive or to limit these principles to any precise form disclosed. Many modifications and variations are possible in light of the above teaching.

What is claimed is:

1. A printing device, comprising:
a build platform to hold an amount of build material thereon; and
a coherent light source to selectively fuse the build material through heat produced by the coherent light source at the surface of the build material;
wherein the coherent light source flood radiates the entirety of the build platform.

2. The printing device of claim 1, wherein the coherent light source is a fiber laser having an energy output and a peak power output proportionate to the area of build material to be fused and delivers more than 30 J/cm² of energy per area and peak power of 5 KW/cm².

3. The printing device of claim 2, comprising a:
collimating lens to collimate electromagnetic radiation emitted from the fiber laser;
beam shaping lens to shape electromagnetic radiation emitted from the fiber laser;
a micromirror array to selectively direct the radiation emitted from the fiber laser to a position on the build platform;
or combinations thereof.

4. The printing device of claim 2, comprising a plurality of fiber lasers each fiber laser emitting a wavelength of electromagnetic radiation to fuse a portion of the build material.

5. The printing device of claim 4, comprising a prism to receive and combine the electromagnetic radiation from the plurality of fiber lasers and direct the electromagnetic radiation to a single fiber laser.

6. The printing device of claim 1, comprising a mask to mask a portion of the build material from the radiation of the coherent light source.

7. The printing device of claim 1, wherein the coherent light source is an array of vertical-cavity surface-emitting lasers (VCSELs).

8. The printing device of claim 7, comprising an array of microlenses to collimate electromagnetic radiation emitted from each of the VCSELs of the VCSEL array.

9. A method for additive manufacturing of metals, comprising:
spreading a build material including a metal in a sequence of layers, each layer having a respective thickness, a respective sequence position, and a respective exposed surface, an entirety of which to be radiantly exposed, in a single application, to an electromagnetic radiation source prior to spreading of a subsequent layer; and
exposing, layer-by-layer, the exposed surface of each layer to the electromagnetic radiation source, the energy radiated at an intensity profile and a fluence sufficient to cause a consolidating transformation of the build material in the exposed layer.

10. The method of claim 9, wherein the electromagnetic radiation is a coherent electromagnetic radiation source from a fiber laser.

11. The method of claim 10, comprising passing the electromagnetic radiation produced by the fiber laser through a collimating lens prior to exposure of the exposed surface.

12. The method of claim 9, wherein the electromagnetic radiation is a coherent electromagnetic radiation source from an array of vertical-cavity surface-emitting lasers (VCSELs).

13. The method of claim 12, comprising passing the electromagnetic radiation produced by each VCSEL through a microlense prior to exposure of the exposed surface.

14. A three-dimensional additive manufacturing printing device, comprising:
a build material distributor to spread a build material including a metal in a sequence of layers;
a build platform to receive the sequence of layers of build material; and
an electromagnetic radiation source to radiantly flood an entirety of each of the layers of build material and selectively fuse the build material;
wherein energy radiated by the electromagnetic radiation source has an intensity profile and a fluence sufficient to cause a consolidating transformation of the build material in the respective exposed layer.

15. The three-dimensional additive manufacturing printing device of claim 14, wherein the electromagnetic radiation source is one of a:
fiber laser;
vertical-cavity surface-emitting laser (VCSEL); or
combinations thereof.
